(19) United States
(12) Patent Application Publication
(10) Pub. No.: US 2019/0315461 A1
(43) Pub. Date: Oct. 17, 2019

(54) ROTARY-WINGED VEHICLE SYSTEMS AND DEVICES

(71) Applicant: Vaughan Lennox Clift, Lone Tree, CO (US)

(72) Inventor: Vaughan Lennox Clift, Lone Tree, CO (US)

(21) Appl. No.: 16/383,513

(22) Filed: Apr. 12, 2019

Related U.S. Application Data
(60) Provisional application No. 62/657,851, filed on Apr. 15, 2018.

(51) Int. Cl. B64C 27/18; B64C 27/06; B64C 27/46; B64D 27/16

(52) U.S. Cl. CPC B64C 27/18; B64D 27/16; B64C 27/463; B64C 27/06

(57) ABSTRACT

Rotary-winged vehicle systems and devices are disclosed. In one aspect, one or more engine components are mounted within rotor blades of the rotary-winged system. In one embodiment, engines are mounted within the rotor blades, with exhaust ports positioned at the rotor blade tips. In another embodiment, the engine of a rotary-winged vehicle includes a centrifugal compressor co-axially mounted with a spindle of the rotor blades. In one aspect, the compressor of one or more engines is decoupled from the engine turbine and electrically driven. In one aspect, the rotary-winged vehicle may be operated autonomously.

### CROSS-REFERENCE TO RELATED APPLICATION

This application is a nonprovisional patent application of and claims the benefit of U.S. Provisional Patent Application No. 62/657,851, filed Apr. 15, 2018 and titled “Aerospace Lifting Body Devices and Components,” the disclosure of which is hereby incorporated herein by reference in its entirety.

### FIELD

The disclosure relates generally to rotary-winged vehicle systems and devices, and more specifically to rotary-winged systems with engines or engine components mounted within rotor blades of the rotary-winged system.

### BACKGROUND

The 1930's and 40's were a very significant era for aerospace, e.g. Juan De La Cierva had already demonstrated his Autogyro and in the 1930's Harold Pitcairn brought it into commercial production. In August 1939 the first jet engine aircraft flew in Germany and a month later Igor Sikorsky flew the first helicopter.

As exciting as the developments were, each had its own fundamental limitations and significant research has not resolved these limitations. An autogyro is a rotary winged aircraft where the rotor is not powered directly. It cannot produce lift unless its rotor is first brought to speed by some drive mechanism that is then disconnected, and the craft is moving forwards or downwards. A helicopter has an engine inside the body of the vehicle which rotates the rotor through a shaft. The drive system often requires complex gearing. The pitch of the rotor blade can alter as it travels through the air allowing the helicopter take off vertically and maneuver in all directions. However, this in turn increases complexity and requires some method to counter torque, the force turning the body of the helicopter in the opposite direction to the rotor. Various systems exist such as having two counter rotating rotors but the commonest is having a tail rotor the pilot controls through a foot control.

Helicopters may be very difficult to fly and require significant training. Failure of the tail rotor is catastrophic. Even though it can take off vertically, a helicopter must achieve a certain height or forward velocity to “autogyro” in the event of engine failure. For this reason, many helicopter fatalities occur in the first 30 feet.

The development of the jet engine has driven significant improvements in materials, but fuel efficiency is still hampered by the different “ideal” speeds of the intake compressor and the exhaust turbine. Some of the energy in the thrust coming from the combustion chamber must be captured to drive the shaft that turns the compressor. To do so efficiently, the turbine must be rotating extremely fast as the air passing it is travelling close to the speed of sound but the compressor, linked directly by a shaft, would ideally rotate much slower so as to be able to compress and slow the incoming air. Due to the high temperatures and extreme RPM, only recently has a gearing system been developed to counter this. It reportedly increases the fuel efficiency by 15% but it two has significant limitations described in greater detail below.

There are other types of jet engines, but the RAMjet must first be travelling close to the speed of sound to operate and pulse jets, though simple in design, produce little thrust. Further discussion below relates to improvement of turbo jet engines only.

Conventional jet engines can be design-limited in function and geometries. For example, conventional turbine jet engines drive a compressor by way of a turbine shaft connected to a turbine, thereby creating compressors of cylindrical shape. Also, conventional jet engines physically couple the air intake portions with the exhaust portions, resulting in a cylindrical shape for most components, such as the combustion chamber. In addition, the rotational speed of the shaft and the centrifugal force created by the high RPM of both turbine and compressor require significant mechanical structure and this increases the weight of the engine.

Some rotary winged aircraft use jet engines to provide the necessary drive. The jet engines do not drive the rotor by providing direct thrust as they do in a fixed wing aircraft but are used to drive a second turbine that is connected to reduction gearing connected to the rotor.

What is needed are rotary-winged systems that provide improved performance and safety by incorporating designs that eliminate the need for torque control and employ alternate turbine jet engine designs. The disclosure provides a solution through mounting of one or more engine components within rotor blades of a rotary-winged system. In one embodiment, engines are mounted within the rotor blades, with exhaust ports positioned at the rotor blade tips. In another embodiment the jet engines are located on a cross bar connected to the rotor shaft. In another embodiment, the design includes an electrical generation system at the central spindle, this incorporates counter rotating rotors to compensate for the torque that may be created. In another embodiment, the engine of a rotary-winged vehicle includes a centrifugal compressor co-axially mounted with a spindle of the rotor blades. In one aspect, the compressor of one or more engines is decoupled from the engine turbine and electrically driven. In one aspect, the rotary-winged vehicle may be operated autonomously. Such features of the aerospace lifting body devices and/or components are described in greater detail below.

### SUMMARY

The present disclosure can provide a number of advantages depending on the particular aspect, embodiment, and/or configuration.

In one embodiment, a rotary-winged vehicle system is disclosed, the system comprising: a plurality of rotor blades mounted to a central spindle, each rotor blade having a rotor blade length and attached to the central spindle at a rotor blade root and extending to a rotor blade tip; a plurality of engines, each engine mounted within an interior of each of the plurality of rotor blades; a plurality of exhaust ports, each exhaust port positioned at a rotor blade tip; a plurality of air intake ports, each air intake port disposed on a surface of each rotor blade; wherein: each of the plurality of air intake ports provide a source of air intake for a respective engine; and each engine propels a respective rotor blade rotationally about the central spindle.

In one aspect, the engine comprises a compressor, a turbine, and a combustion chamber. In another aspect, the compressor is configured to receive the source of air intake from a respective intake port. In another aspect, the engine further comprises a drive shaft coupled to the turbine and to the compressor, wherein the drive shaft provides power to the compressor. In another aspect, the system further comprises a power source, the power source configured to provide power to the compressor. In another aspect, the power source is an electric power source configured to provide electrical power to the compressor. In another aspect, the system further comprises a controller configured to control operating parameters of the engine. In another aspect, the controller is further configured to control a configuration of the plurality of air intake ports. In another aspect, the system further comprises a nozzle disposed within each of the plurality of rotor blades and positioned between a respective engine and rotor tip. In another aspect, the system further comprises a plurality of sets of exhaust port vanes, each set of exhaust port vanes coupled to a respective exhaust port.

In another embodiment, a rotary-winged vehicle system is disclosed, the system comprising: a plurality of rotor blades mounted to a central spindle, each rotor blade having a rotor blade length and attached to the central spindle at a rotor blade root and extending to a rotor blade tip; a fluid pipe disposed within a plurality of rotor blades; a centrifugal compressor mounted coaxial with the central spindle; a plurality of fluid collector-diffuser devices coupled to the centrifugal compressor; and a plurality of combustion chambers coupled to a respective fluid pipe; wherein: each of the plurality of fluid collector-diffuser devices receive a fluid from the centrifugal compressor and output the fluid to a respective fluid pipe; each of the fluid pipes output the fluid to a respective fluid pipe; each of the combustion chambers outputs to an exhaust port; and each respective rotor blade is propelled rotationally about the central spindle.

In one aspect, each exhaust port is disposed at a rotor tip. In another aspect, the system further comprises an electric generator coupled to the central spindle. In another aspect, the system further comprises an electric motor in communication with the electric generator. In another aspect, the electric motor at least partially provides power to the plurality of combustion chambers. In another aspect, the plurality of combustion chambers are disposed at a rotor tip. In another aspect, the plurality of combustion chambers are disposed within the rotor length. In another aspect, each combustion chamber is disposed within each rotor blade. In another aspect, the system further comprises a plurality of sets of exhaust port vanes, each set of exhaust port vanes coupled to a respective exhaust port. In another aspect, the system further comprises a controller configured to control operating parameters of the plurality of combustion chambers.

In yet another embodiment, a jet engine system for a flying vehicle is disclosed, the system comprising: a compressor; a turbine; a combustion chamber; an exhaust port; and a power source; wherein: the power source powers the combustion chamber; the compressor operates independently of the turbine; the combustion chamber receives compressed air from the compressor and outputs to the exhaust port.

In one aspect, the power source is an electric power source. In another aspect, the combustion chamber is of a non-circular geometric cross-section. In another aspect, the flying vehicle is a rotary-winged flying vehicle. In another aspect, the system further comprises a controller controlling operating parameters of the compressor. In another aspect, the system further comprises a set of exhaust port vanes coupled to the exhaust port.

The phrase “rotary-winged vehicle” and “rotary-winged vehicle system” means a heavier-than-air flying machine that uses lift generated by wings which revolve around a spindle or mast, to include helicopters and autogyros.

The phrase “turbine engine” means an engine that uses a turbine to compress incoming air which feeds an engine before being ejected to push a vehicle or a component forward.

The phrase “electric generator” means a device that converts mechanical energy to electrical energy for use in an external circuit.

The phrase “electric motor is an electrical machine that converts electrical energy into mechanical energy

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably. The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that can perform the functionality associated with that element.

The phrase “graphical user interface” or “GUI” means a computer-based display that allows interaction with a user with aid of images or graphics.

The term “computer-readable medium” as used herein refers to any storage and/or transmission medium that participate in providing instructions to a processor for execution. Such a computer-readable medium is commonly tangible, non-transitory, and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 shows a perspective view of a conventional rotary-winged vehicle of the prior art;

FIG. 2A shows a cut-away partial top view of one embodiment of a rotary-winged vehicle system;

FIG. 2B shows a cut-away partial front_ view of the embodiment of a rotary-winged vehicle system of FIG. 2A;

FIG. 2C shows a cut-away partial side view of the embodiment of a rotary-winged vehicle system of FIG. 2A;

FIG. 3A shows a cut-away partial top view of another embodiment of a rotary-winged vehicle system;

FIG. 3B shows a cut-away partial front view of the embodiment of a rotary-winged vehicle system of FIG. 3A;

FIG. 3C shows a cut-away partial side view of the embodiment of a rotary-winged vehicle system of FIG. 3A;

FIG. 4A shows a cut-away partial top view of another embodiment of a rotary-winged vehicle system with a centrifugal compressor;

FIG. 4B shows a cut-away partial front_ view of the embodiment of a rotary-winged vehicle system of FIG. 4A;

FIG. 4C shows a cut-away partial side view of the embodiment of a rotary-winged vehicle system of FIG. 4A;

FIG. 5A shows a cut-away partial top view of another embodiment of a rotary-winged vehicle system with a centrifugal compressor;

FIG. 5B shows a cut-away partial front view_ of the embodiment of a rotary-winged vehicle system of FIG. 5A;

FIG. 5C shows a cut-away partial side view of the embodiment of a rotary-winged vehicle system of FIG. 5A; and

FIG. 6 shows one embodiment of a control system of a rotary-winged vehicle system.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

Not included for simplicity but implicit in the design is the addition of mechanisms variously referred to as cyclics and collectives that could be added to the spindle and alter the pitch of the rotor blade as it traverses around the spindle to provide additional control to the vehicle.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

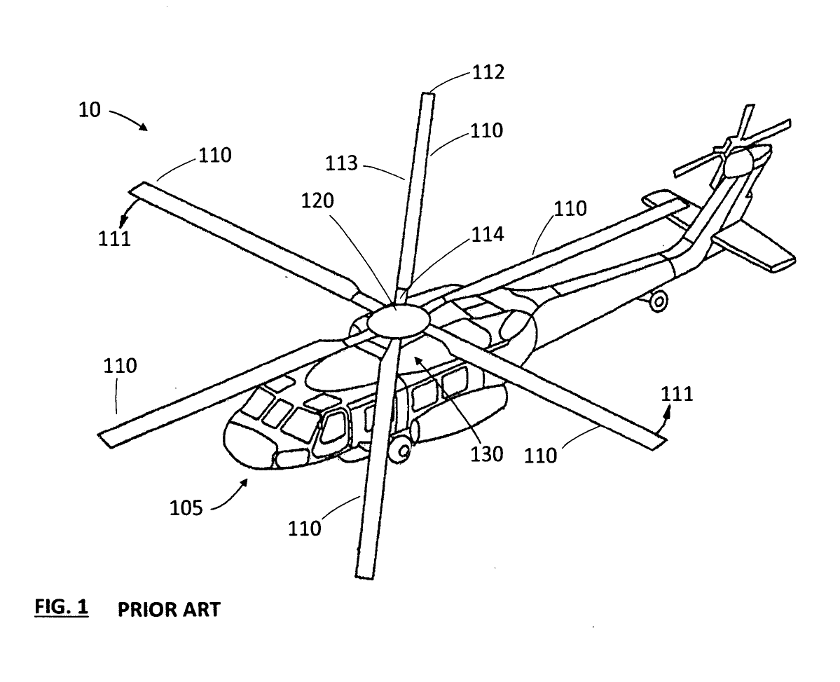

A perspective view of a conventional rotary-winged vehicle 10 of the prior art is provided as FIG. 1. Generally, the conventional rotary-winged vehicle 10 comprises one or more engines 130 mounted within a body 105 of the vehicle 10. A set of rotor blades 120 aka “rotors” are distributed about a central spindle 120, the set of rotor blades rotating about the central spindle 120. The central spindle is propelled in a rotatory motion about a central axis by the one or more engines 130. Each of the rotor blades 110 comprise a rotor blade tip 112, a rotor blade root 114, and a rotor blade length 113. The conventional rotary-winged vehicle 10 comprises a set of five rotor blades.

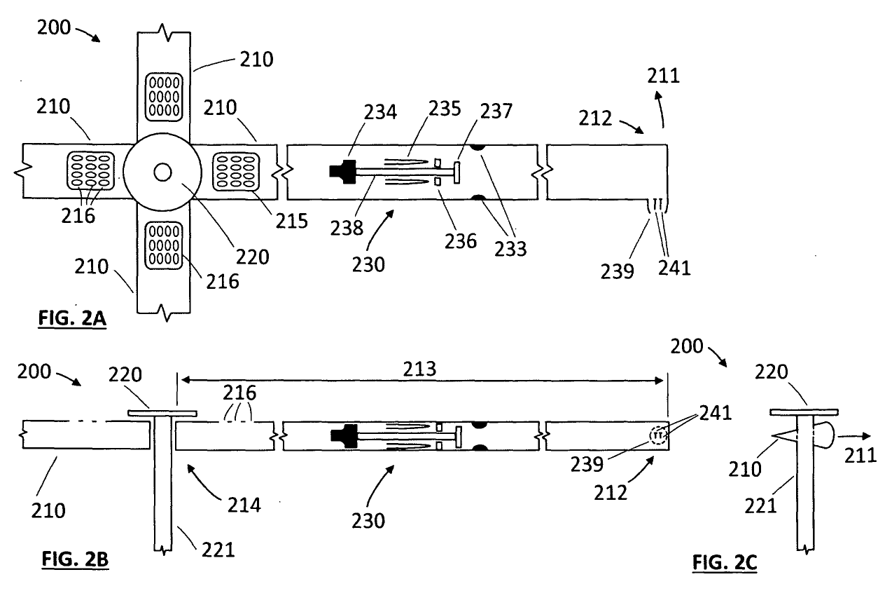

In contrast, the disclosure presents embodiments of rotary-winged systems wherein one or more engine components, or complete engines, are mounted within an interior of rotor blades of a rotary-winged system. Such configurations provide a number of advantages which will be discussed below. The embodiments of the disclosure and associated features will be described with respect to FIGS. 2-6, with some reference to the conventional rotary-winged vehicle 10 of the prior art depicted in FIG. 1.

In one embodiment, engines are mounted within the rotor blades, with exhaust ports positioned at the rotor blade tips. In another embodiment, the engine of a rotary-winged vehicle includes a centrifugal compressor co-axially mounted with a spindle of the rotor blades. In one aspect, the compressor of one or more engines is decoupled from the engine turbine and electrically driven. In one aspect, the rotary-winged vehicle may be operated autonomously.

With attention to FIGS. 2A-C, a respective cut-away partial top-view, front-view, and side-view of a rotary-winged system 200 is depicted. The rotary-winged system 200 may also be referred to as “system.” Generally, the rotary-winged system 200 comprises a set or plurality of rotor blades 210 mounted at equidistant radials about a central spindle, the central spindle comprising a spindle top 220 and spindle shaft 221. Rotor blade 210 may also be referred to as “rotor.” The FIGS. 2A-C do not illustrate all aspects of the rotary-winged system 200 for simplicity and clarity; for example, the collective mechanisms associated with the central spindle area are not depicted. Generally, those components of a conventional rotary-winged vehicle system, as known to those skilled in the art, that are not depicted are provided in the rotary-winged system 200 in a similar manner or implementation. For example, each rotor would include a rotary union for transmission of fuel and an electrical slip ring for transmission of electrical power, among other things.

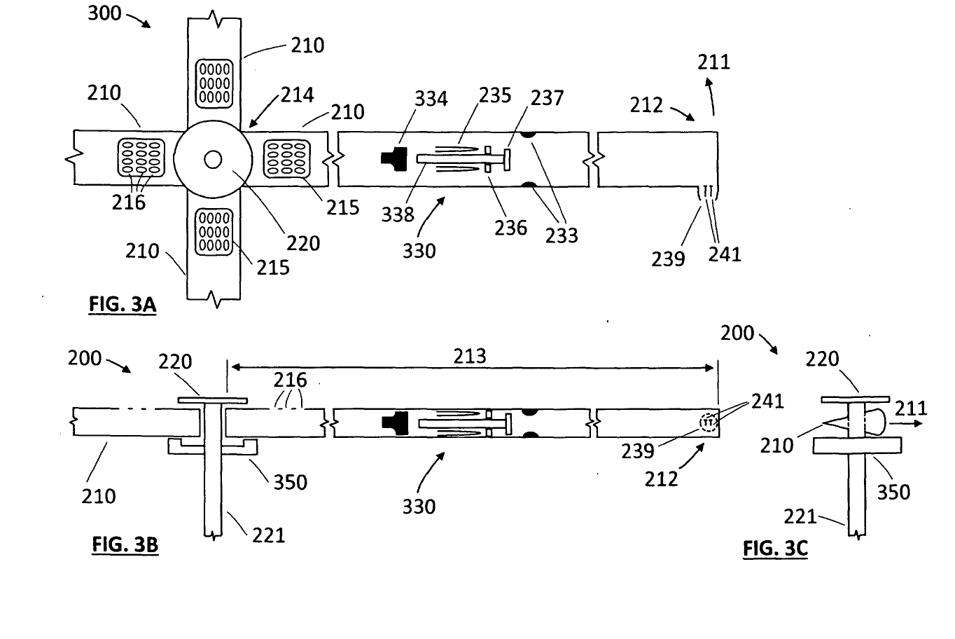

The rotary-winged system 200 of FIGS. 2A-C, and of FIGS. 3A-C, may be termed an in-rotor and rotor tip turbine jet engine design, and creates a powered “autogyro” rotor wing with no counter torque required and minimal drag to permit autogyro flight in case of emergency.

The prior art includes RAMjet engines, pulse jet engines, and various rocket engines at the tips of the rotor of a rotary wing craft. Such designs may eliminate the torque generated by the hub or in vehicle engines. The lack of torque is advantageous because, e.g., it eliminates the need for a tail rotor or other similar anti torque system. Many of the problems associated with rotary wing aircraft, including difficulty to control, relatively high noise, hazard to nearby individuals and mechanical failure, relate to the need for a tail rotor.

However, many existing designs to eliminate the tail rotor are limited by the increased drag associated with the tip engines, often preventing the rotor to autogyro and creating a significant safety concern. Other existing designs describe the use of an in-rotor pulse jet engine and “pressure jet” variants as an alternative to tip engines. However, none of the existing designs have ever been demonstrated as viable flight options. Pulse jets, and related variations, though very simple and light weight in design, produce too little thrust to create sufficient rotation and thus provide insufficient lift.

The disclosure uses modern micro turbo jet engines that can produce sufficient thrust without increasing the drag significantly. In one embodiment, the intake for the jet engine is directed toward the hub of the rotor, and the thrust vectors out of a shrouded exhaust, thus providing the necessary rotation but not increasing rotor drag. In another embodiment, the turbine and the shaft components are not present, thrust is vectored out from the rotor tip, and the rotation of the rotor drives a hub-based generator or mechanical drive that drives the compressor directly or electrically.

Returning to FIGS. 2A-C, each rotor blade 210 comprises a rotor tip 212 and a rotor blade root 214. Each rotor blade 210 has a rotor blade length 213 defined by the distance between the rotor blade tip 212 and the rotor blade root 214. Each rotor blade 210 is coupled to the central spindle shaft 221 at or near a rotor blade root 214 and rotates relative to the spindle shaft 221 in a rotational direction 211. In the embodiment presented, the set of rotor blades 210 number four. In other embodiments, the set of rotor blades 210 number two or more, such as three, four, five, six, etc. Each rotor blade 210 comprises a cross-sectional profile of an aerodynamic shape, as provided in FIG. 2C. More, specifically, each rotor blade 211 is configured with a leading edge (the edge that leads the rotational direction 211) of greater thickness than the trailing edge. Although a symmetrical airfoil shape is depicted in FIG. 2C, any aerodynamic or airfoil shape known to those skilled in the art may be used, to include cambered shapes. Also, although the profile or cross-section of the rotor blade 210 is depicted in a “clean” aerodynamic shape, the rotor blade may comprise additional aerodynamically-disruptive features, such as flaps, as known to those skilled in the art.

One or more rotor blades 210 comprise an engine 230 mounted within an interior of a rotor blade 210. In the cut-away depiction of a rotary-winged system 200 in FIGS. 2A-C, only one engine 230 is depicted for clarity purposes. In each embodiment of the rotary-winged system 200, there would be a plurality of engines 230 of total number depending on the number of rotor blades 210. Specifically, the number of engines 230 would always be an even number and symmetrically mounted, although not required to be mounted in every rotor blade 210. For example, in an embodiment of the rotary-winged system 200 with four rotor blades 210, the set of engines 230 may number two or four, wherein the two-engine configuration would provide an engine 230 mounted on alternating rotor blades. Stated another way, in a four-blade rotary-winged system 200 configuration a pair of engines may be mounted on rotor blades 210 one and three at respective 0-degree and 180-degree positions. Such arrangements provide a configuration balanced in weight.

In the configuration of FIGS. 2A-C, in addition to the engine 230 depicted positioned within the 90 degree rotor blade 210 position (i.e. the rotor blade at the 3 o'clock position), another three engines 230 would be positioned within each of the respective other three rotor blades 210, i.e. one additional engine 230 at each of 180 degrees (6 o'clock), 270 degrees (9 o'clock), and at 0 degrees (12 o'clock). Each of the engine 230—rotor blade 210 configurations on each of the four rotor blades 210 would be identical and create a symmetrical arrangement.

In another embodiment, a four-bladed system 200 comprises a total of two engines 230, one at a rotor blade 210 at the 90-degree position and a second engine 230 at the opposite rotor blade 210 at the 270-degree position (i.e. the 9 o'clock position). The configurations of these two rotor blades 210, i.e. the rotor blades at the 90 degree and at the 270-degree position, would be identical and create a symmetrical arrangement.

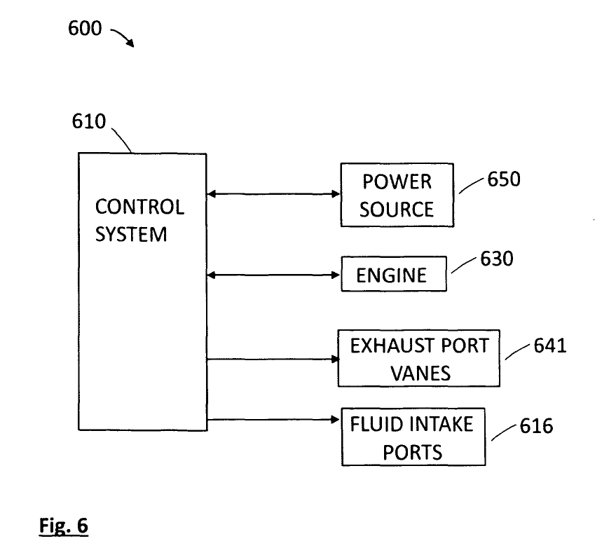

Each rotor blade 210 that houses or contains an engine 230 comprises an air intake port 215 comprising an array or set of voids 216 or apertures configures to receive a fluid such as air. In the configuration depicted in FIG. 2A, each air intake port 215 comprises a set or array of nine voids 216. Each air intake port 215 may be mounted on or adjacent a surface of a respective rotor blade 210. Other configurations for the air intake port 215 are possible. For example, the air intake port 215 may comprise only one void 216, or any configuration of air intake voids known to those skilled in the art. In one embodiment, one or more of the voids 216 are configurable by way of a control system 610 (see FIG. 6 and associated discussion), the configuration comprising, for example, the amount of void presented. Stated another way, the volume of air intake and/or amount of void space presented is configurable and controllable.

Engine 230 comprises a compressor 234, combustion chamber 235, set of stators 236, a turbine 237 engaged with a turbine shaft 238, and nozzle 233. In one embodiment, other than the relatively small size of the engine 230, the engine 230 of FIGS. 2A-C is broadly similar to a conventional turbine jet engine. The engine 230 receives input air from the root-side of the rotor blade 210 or proximal to the air intake port 215. The air injected or received by an air intake port 215 is provided to a hollowed area within the rotor blade 210 and provided to the compressor 234. After compressing the received air, the now-compressed air is provided to the combustion chamber 235. The combustion chamber 235 mixes the received compressed air with fuel and ignites the mixture. The ignited fuel/air mixture then enters stators 236. The stators 236 comprise a series of stationary blades which direct the outgoing produced thrust. Downstream, or away from the rotor blade hub 214 and toward the rotor blade tip 212, a nozzle 233 is positioned. The nozzle 233 may further redirect the outgoing produced thrust. Note that the turbine 237, in the configuration of FIG. 1A-C, collects a portion of the produced thrust and rotates turbine shaft 238. The turbine drive shaft 238 transmits rotary motion from the turbine 237 to the compressor 234. Finally, an exhaust port 239 directs, with aid of one or more exhaust port vanes 241, the generated thrust out from the rotor blade 210. Generally, the thrust is nominally directed in the same plane as the rotor blades and at right angles to the axis of the rotor blades 210. However, the one or more exhaust port vanes 241 may vector the thrust out of this nominal direction. For example, the thrust may be directed slightly downward for additional vertical thrust of the rotary winged system 200. In one embodiment, one or more of the exhaust port vanes 241 are configurable by way of a control system 610 (see FIG. 6 and associated discussion), the configuration comprising, for example, the orientation or deflection of the amount of the one or more of the exhaust port vanes 241.

FIGS. 3A-C depict another embodiment of a rotary-winged vehicle system 300 similar to the rotary-winged vehicle system 200 of FIGS. 2A-C, except that the compressor is decoupled from a turbine shaft of a turbine and powered by another source. Stated another way, in the rotary-winged vehicle system 300 embodiment, the compressor 334 is powered by a means other than a turbine shaft of a turbine.

The rotary-winged vehicle system 300 comprises a power generator 350, such as an electric power generator. The power generator 350, among other things, provides power to the compressor 334. Such a configuration may be termed an electrically-decoupled turbine engine design. In the configuration of FIGS. 3A-C, the power generator 350 is an electrical power generator which converts the rotation motion of the spindle shaft 221 into electrical power, the electrical power driving the compressor 334. In another embodiment, an electric motor drives, with rotational motion similar to that of a conventional turbine drive, the compressor 334. In one embodiment, the power generator 350 drives an electric motor which in turn drives the compressor 334. Other aspects and features of the rotary-winged vehicle system 300 are similar to the rotary-winged vehicle system 200 of FIGS. 2A-C.

Note that an electrically-decoupled turbine engine design allows non-traditional designs for the combustion chamber because the combustion chamber is no longer driven by a rotating shaft (which results in combustion chambers of traditionally cylindrical shape). In contrast, an electrically-decoupled turbine engine design is not design driven to be of cylindrical shape, and thus may be optimized for other parameters, resulting in essentially any shape in addition to a cylindrical shape. In addition, such separation of intake, compressor, combustion chamber of varied geometry and variable location of the exhaust thrust can be applied to fixed wing as well as rotary wing designs.

Conventional centrifugal and co-axial turbo jet designs use a single shaft connecting the rear turbine to the forward compressor element. This shaft transfers a portion of the thrust captured by the rear turbine and converts the energy into rotary motion to drive the compressor. The intake air is compressed and sent to the combustion chamber to provide increased efficiency of combustion fundamental to the engines function.

Typically, approximately 25% of the energy in the exhaust thrust is captured and used to drive the compression phase. However, due to differences in the velocity of airflow at the intake and the exhaust and the possible range of velocities, it has been very difficult if not impossible to design a system where both the rear turbine and front compressor are functioning optimally when rotating at identical speed, and thus the potential maximum efficiency is compromised. One design, by McCune as described in, e.g., U.S. Pat. No. 9,752,511 (“McCune”), is to modify the straight shaft with a gearing system to permit the turbine and compressor to operate at different rotational speeds while still directly driven. The design is reported to have improved efficiency by as much as 15%. However, this design is still limited in that increasing and decreasing thrust still requires the shaft driven compressor and turbine to spin up or spin down in response to increased or decreased thrust from the combustion chamber and is subject to significant inertia. It is also somewhat constrained by the air-fuel ratio entering the combustion chamber in that as fuel is increased, there is a period where the fuel mixture is rich until the compressor spins up and additional air flows into the combustion chamber. It is therefore possible to flood the engine with fuel and potentially cause the engine to fail or flame out, limiting the rate at which thrust can be increased. McCune is incorporated by reference for all purposes.

In the rotary-winged vehicle system 300 of FIGS. 3A-C, an electric generator 334 (and/or an electric motor) directly drives the compressor 334, which provides several advantages over the traditional approach. As non-limiting examples, firstly, the compressor-motor combination can be designed to operate at an optimal speed of rotation for intake air speed and density. Secondly, the compressor speed can be increased in parallel with fuel flow and, when needed, additional energy may be provided from a multiplicity of sources to increase the compressor 334 rotation. Conventional designs are limited, e.g. the inertia of the turbine 237 and turbine shaft limit how quickly the speed of rotation can be increased, and the proportion of the thrust energy collected by the turbine 237 cannot be varied. Thirdly, for the same reasons, thrust can be decreased actively by decreasing the compressor speed and fuel flow in parallel more quickly than with the conventional designs.

In yet another embodiment, there is no turbine connected to a generator and the electrical power is generated by a multiplicity of other sources, including but not limited to the movement of the vehicle itself, a rotor powered by the jet thrust, or a separately fueled power source.

Other embodiments of a rotary-winged vehicle system similar to those of FIGS. 2A-C and 3A-C are possible. For example, the location of the engine may be at any location of the rotor blade, to include at an approximately middle or medial location, within the first quarter of the length of the rotor blade, as measured from the rotor blade root to the rotor blade tip, and within the last quarter of the length of the rotor blade.

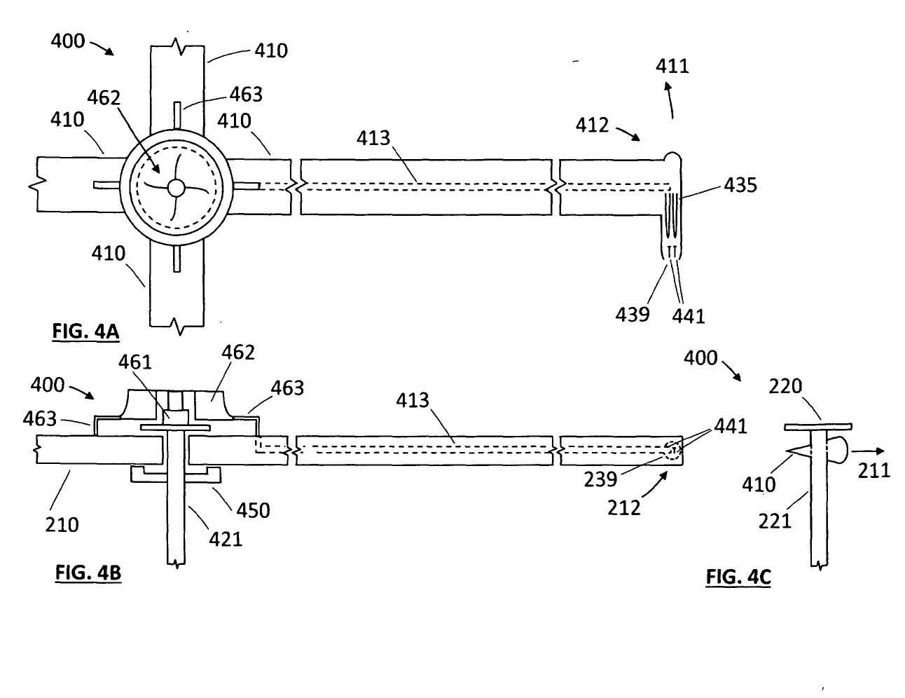

With attention to FIGS. 4A-C, a respective cut-away partial top-view, front-view, and side-view of a rotary-winged system 400 is depicted. Generally, the rotary-winged system 400 comprises a centrifugal compressor 462 mounted coaxially with a central spindle shaft 421.

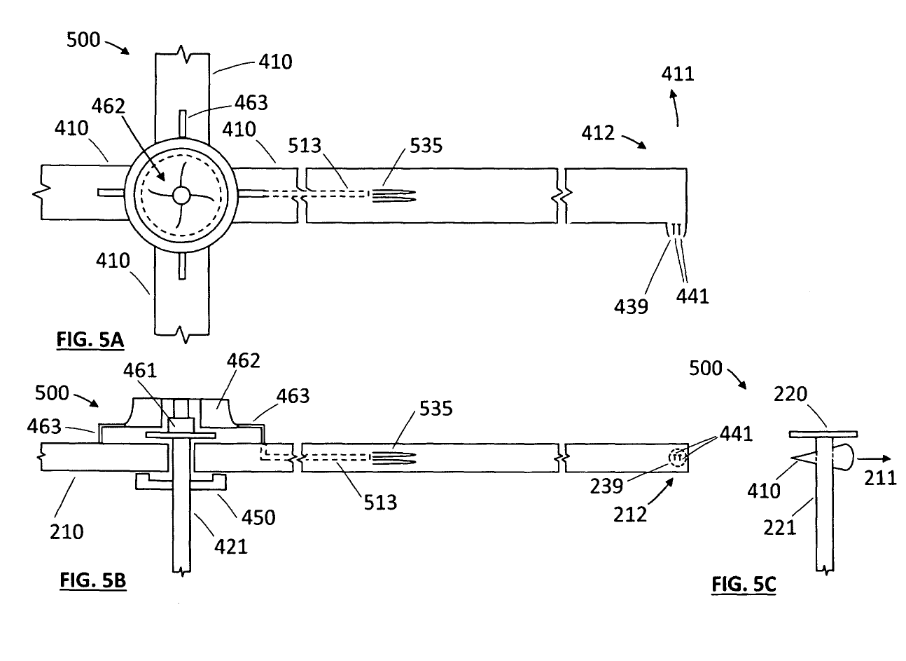

The rotary-winged system 400 further comprises an electric motor 461 and an electrical generator 450, both coaxially mounted about a central spindle shaft 421. The electrical generator 450 generates electricity by way of the rotation of the shaft 421, and supplies electricity to the electric motor 461; which in turn powers the centrifugal compressor 462. The centrifugal compressor 462 provides compressed air to the combustion chamber 435, which in turn expels thrust through exhaust 439. In the embodiment of FIGS. 4A-C, the one or more compressors 435 are positioned at the rotor tips 412, and in the embodiment of FIGS. 5A-C, the one or more combustion chambers 535 are positioned within the rotor blade 410 length.

The rotary-winged system 400 of FIGS. 4A-C and the rotary-winged system 500 of FIGS. 5A-C may be termed, respectively, rotor tip turbine jet engine designs and in-rotor turbine jet engine designs. Each of these embodiments create a powered “autogyro” rotor wing with no counter torque required and minimal drag to permit autogyro flight in case of emergency.

Returning to FIGS. 4A-C, a set or plurality of rotor blades 410 mounted at equidistant radials. The FIGS. 4A-C do not illustrate all aspects of the rotary-winged system 400 for simplicity and clarity; for example, the collective mechanisms associated with the central spindle area are not depicted. Generally, like the embodiments depicted in FIGS. 2A-C and FIGS. 3A-C, those components of a conventional rotary-winged vehicle system, as known to those skilled in the art, that are not depicted are provided in the rotary-winged system 400 in a similar manner or implementation. For example, each rotor would include a rotary union for transmission of fuel and an electrical slip ring for transmission of electrical power, among other things.

The centrifugal compressor 462 is located centrally at a rotor hub area and is driven by electric motor 461. The centrifugal compressor 462 is located coaxially to the centrally located motor 461 and generator 450, the generator 450 itself connected radially to the set of rotor blade 410. Compressed air from the centrifugal compressor 462 is piped down, via fluid pipe 413, to and along one or several of the rotor blades 410 to a combustion chamber 435. The compressed air is received by a fluid pipe contained within a rotor blade 410, the fluid pipe 413 disposed within an interior of the rotor blade 410. The compressed air is mixed with fuel, liquid or gas, which is burned to produce thrust out exhaust pipe 439. The combustion chamber 435 is located at a distal (or radially far) point of the rotor bland 410 (i.e., at the rotor tip 412) and positioned such that the exhaust thrust causes the rotor to rotate about the central shaft 421 and thus generate lift.

The exhaust port 439 directs, with aid of one or more exhaust port vanes 441, the generated thrust out from the rotor blade 410. Generally, the thrust is nominally directed in the same plane as the rotor blades and at right angles to the axis of the rotor blades 410. However, the one or more exhaust port vanes 441 may vector the thrust out of this nominal direction. For example, the thrust may be directed slightly downward for additional vertical thrust of the rotary winged system 400.

In one embodiment, one or more of the exhaust port vanes 441 are configurable by way of a control system 610 (see FIG. 6 and associated discussion), the configuration comprising, for example, the orientation or deflection of the amount of the one or more of the exhaust port vanes 441.

FIGS. 5A-C depict another embodiment of a rotary-winged vehicle system 500 similar to the rotary-winged vehicle system 400 of FIGS. 4A-C, except that the compressor is disposed within the rotor blade 410 rather than at a rotor blade tip 412. After the air is exhausted from the compressor, the exhaust air travels the remaining distance of the rotor blade and is emitted at exhaust pipe 439.

The electrical generator 450 is coupled to the electric motor 461. The electric motor 461 rotates the centrifugal compressor 462. The electric motor 461 may be connected to the spindle shaft 421 and/or to the rotor blades 412. The collector-diffuser 463 directs and slows the compressed air from the centrifugal compressor 462 to the inside of each of the rotor blades 410.

In one embodiment, a portion of the compressed air generated by the centrifugal compressor 462 may be siphoned off to perfuse ultra-low resistance air bearings or provide cooling to the hub based electric motor 400. Furthermore, in one embodiment, the rotation of the rotor blades 410, as attached to the motor 463 and/or generator 450, may be used to generate electrical power to variously charge storage batteries or to power attached devices. Alternatively, or additionally, the power from the storage batteries may be used to drive the hub-based motor to rotate the rotor blades and to create lift, in addition to or instead of the gas-powered jet engine components.

Each of the rotary-winged vehicle system 400 and 500 may create lift using electric power for a certain period of time, then hydrocarbon power (e.g. gasoline, diesel, propane) to create lift for powered flight for another period of time. Also, the embodiment may also recharge storage batteries or power electrical instruments or devices (e.g. pumps, floodlights, winches). It should be noted that each of the rotary-winged vehicle system 400 and 500 would require some means for counter-torque given the torque generated by, e.g., the power generating system 450. The counter-torque may be provided by any of several techniques, to include a conventional tail rotor, a rotor blade system mounted above or below that depicted in FIGS. 4A-C and FIGS. 5A-C to create a pair of counter-rotating rotor blade systems, and other techniques known to those skilled in the art.

It should be noted that in some embodiments of the disclosed rotary-winged vehicle systems, the input elements to an engine are physically separate from the exhaust/thrust elements, enabling a larger design space for both engine design and rotary-winged vehicle system design. This is because conventional rotary-winged vehicle systems comprise engines in which the engine input elements (e.g. the input nozzle and air intake sections are positioned in a front cylindrical portion of an essentially continuous cylindrically-shaped engine, with the exhaust/thrust portion at the rear of the cylinder.

In one embodiment, an auxiliary engine, such as a traditional Auxiliary Power Unit (APU) of conventional commercial airliners, is used to power a compressor of an engine (rather than by a turbine shaft engaged by a turbine).

FIG. 6 shows one embodiment of a control system of a rotary-winged vehicle system. The control system 610 may interact with any collection of the components of the rotary-winged vehicle systems and associated components described above with respect to FIGS. 2-5.

For example, the control system 610 may interact with and control an electric power source to selectively power a rotary-winged system for a selected period of time, then switch to another power source, e.g. burning of a traditional hydrocarbon. The control system 610 may also control recharging of storage batteries or power electrical instruments or devices.

As further examples, the control system 610 may interact with and control engine parameters, such as combustion chamber temperature, pressure, etc. The control system 610 may also control the amount or degree of exposure or size of the voids 216 of FIGS. 2A-C, and/or control the one or more of the exhaust port vanes 241.

Also, the control system 610 may be configured to operate the rotary-winged system embodiments fully autonomously, i.e. without a human aboard the system.

In some embodiments, the rotary-winged vehicle may be configured to hover with need of forward speed, a capability particularly beneficial for safety during emergency flight conditions.

The above embodiments may, in combination or separately, may utilize computer software and/or computer hardware (to include, for example, computer-readable mediums) for any of several functions such as automated control and state estimation, and furthermore may utilize one or more GUIs for human interaction with modules or elements or components.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The exemplary systems and methods of this disclosure have been described in relation to rotary-winged vehicle systems and devices. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A rotary-winged vehicle system comprising:
a plurality of rotor blades mounted to a central spindle, each rotor blade having a rotor blade length and attached to the central spindle at a rotor blade root and extending to a rotor blade tip;
a plurality of engines, each engine mounted within an interior of each of the plurality of rotor blades;
a plurality of exhaust ports, each exhaust port positioned at a rotor blade tip;
a plurality of air intake ports, each air intake port disposed on a surface of each rotor blade; wherein:
each of the plurality of air intake ports provide a source of air intake for a respective engine; and
each engine propels a respective rotor blade rotationally about the central spindle.

2. The system of claim 1, wherein:
the engine comprises a compressor, a turbine, and a combustion chamber; and
the compressor is configured to receive the source of air intake from a respective intake port.

3. The system of claim 2, wherein the engine further comprises a drive shaft coupled to the turbine and to the compressor, wherein the drive shaft provides power to the compressor.

4. The system of claim 2, wherein the system further comprises a power source, the power source configured to provide power to the compressor.

5. The system of claim 4, wherein the power source is an electric power source configured to provide electrical power to the compressor.

6. The system of claim 2, wherein the system further comprises a controller configured to control operating parameters of the engine and to control a configuration of the plurality of air intake ports.

7. The system of claim 1, further comprising:
a nozzle disposed within each of the plurality of rotor blades and positioned between a respective engine and rotor tip; and
a plurality of sets of exhaust port vanes, each set of exhaust port vanes coupled to a respective exhaust port.

8. A rotary-winged vehicle system comprising:
a plurality of rotor blades mounted to a central spindle, each rotor blade having a rotor blade length and attached to the central spindle at a rotor blade root and extending to a rotor blade tip;
a fluid pipe disposed within a plurality of rotor blades;
a centrifugal compressor mounted coaxial with the central spindle;
a plurality of fluid collector-diffuser devices coupled to the centrifugal compressor; and
a plurality of combustion chambers coupled to a respective fluid pipe; wherein:
each of the plurality of fluid collector-diffuser devices receive a fluid from the centrifugal compressor and output the fluid to a respective fluid pipe;
each of the fluid pipes output the fluid to a respective fluid pipe;
each of the combustion chambers outputs to an exhaust port; and
each respective rotor blade is propelled rotationally about the central spindle.

9. The system of claim 8, wherein each exhaust port is disposed at a rotor tip.

10. The system of claim 8, wherein each combustion chamber is disposed within each rotor blade.

11. The system of claim 8, further comprising:
an electric generator coupled to the central spindle; and
an electric motor in communication with the electric generator, wherein:
the electric motor at least partially provides power to the plurality of combustion chambers.

12. The system of claim 8, wherein each combustion chambers is disposed at a rotor tip.

13. The system of claim 8, further comprising a plurality of sets of exhaust port vanes, each set of exhaust port vanes coupled to a respective exhaust port.

14. The system of claim 8, further comprising a controller configured to control operating parameters of the plurality of combustion chambers.

15. A jet engine system for a flying vehicle, the system comprising:
a compressor;
a turbine;
a combustion chamber;
an exhaust port; and
a power source; wherein:
the power source powers the combustion chamber;
the compressor operates independently of the turbine;
the combustion chamber receives compressed air from the compressor and outputs to the exhaust port.

16. The system of claim 15, wherein the power source is an electric power source.

17. The system of claim 15, wherein the combustion chamber is of a non-circular geometric cross-section.

18. The system of claim 15, wherein the flying vehicle is a rotary-winged flying vehicle.

19. The system of claim 15, further comprising a controller controlling operating parameters of the compressor.

20. The system of claim 15, further comprising a set of exhaust port vanes coupled to the exhaust port.
